(19) United States
(12) Patent Application Publication
(10) Pub. No.: US 2017/0286665 A1
(43) Pub. Date: Oct. 5, 2017

(54) DEVICES AND METHODS FOR FACILITATING SOFTWARE SIGNING BY MORE THAN ONE SIGNING AUTHORITY

(71) Applicant: QUALCOMM Incorporated, San Diego, CA (US)

(72) Inventors: Maria Miranda, Pune (IN); Satyajit Patne, San Diego, CA (US)

(21) Appl. No.: 15/263,170

(22) Filed: Sep. 12, 2016

Related U.S. Application Data
(60) Provisional application No. 62/315,594, filed on Mar. 30, 2016.

(51) Int. Cl. G06F 21/44; G06F 21/54

(52) U.S. Cl. CPC G06F 21/44; G06F 21/54; G06F 9/4406

(57) ABSTRACT

Electronic devices are adapted to facilitate execution of software signed by more than one entity. According to one example, an electronic device can store software including a hash table segment. The hash table segment can include at least one hash entry, a first signature and first certificate chain from a first entity for the at least one hash entry, and a second signature and second certificate chain from a second entity for the at least one hash entry. The electronic device may validate the first and second signatures. If both the first and second signatures are validated, the electronic device can execute the software. Other aspects, embodiments, and features are also included.

### PRIORITY CLAIM

The present application for patent claims priority to Provisional Application No. 62/315,594 entitled “Devices and Methods for Facilitating Software Signing by More Than One Signing Authority” filed Mar. 30, 2016, and assigned to the assignee hereof and hereby expressly incorporated by reference herein.

### TECHNICAL FIELD

The technology discussed below relates generally to software security, and more specifically, though not exclusively, to methods and devices for facilitating software signing from more than one entity.

### BACKGROUND

Software signing is a widely used method for ensuring that an electronic device runs only code that it is intended to and that code has been provided by a trusted party. Having control over which software runs on an electronic device is important for several reasons: safety of the device, privacy of the consumer, brand protection, certification of the device, complying with legislation authorities, protecting the software asset of the device, enabling application and service business, etc. Losing control over executable software can have serious impacts both to consumers and to device manufacturers.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Various examples and implementations of the present disclosure facilitate software signing by multiple entities. According to at least one aspect of the disclosure electronic devices are disclosed, which are adapted to facilitate execution of software with signatures from more than one entity. In at least one example, electronic devices may include a storage medium and a processing circuit coupled to the storage medium. The storage medium may store a first software comprising a hash table segment, the hash table segment comprising at least one hash entry, a first signature and first certificate chain from a first entity for the at least one hash entry, and a second signature and second certificate chain from a second entity for the at least one hash entry. The processing circuit may be adapted to validate the first signature and the second signature, and execute the software after validating both the first signature and the second signature.

Additional aspects of the present disclosure include methods operational on an electronic device and/or means for performing such methods. According to at least one example, such methods may include obtaining a first software comprising a hash table segment, the hash table segment comprising at least one hash entry, a first signature and first certificate chain from a first entity for the at least one hash entry, and a second signature and second certificate chain from a second entity for the at least one hash entry. The first signature and the second signature may each be validated, and the first software may be executed after validating both the first signature and the second signature.

Still further aspects of the present disclosure include processor-readable storage mediums storing processor-executable programming. In at least one example, the processor-executable programming may be adapted to cause a processing circuit to store a first software comprising a hash table segment, the hash table segment comprising at least one hash entry, a first signature and first certificate chain from a first entity for the at least one hash entry, and a second signature and second certificate chain from a second entity for the at least one hash entry. The processor-executable programming may further be adapted to cause a processing circuit to authenticate the first signature, authenticate the second signature, and execute the first software after both the first signature and the second signature have been authenticated.

Other aspects, features, and embodiments associated with the present disclosure will become apparent to those of ordinary skill in the art upon reviewing the following description in conjunction with the accompanying figures.

### DRAWINGS

FIG. 1 is a block diagram illustrating select components of an electronic device according to at least one example of the present disclosure.

FIG. 2 is a block diagram illustrating select components of a secure execution environment in the electronic device of FIG. 1.

FIG. 3 is a block diagram illustrating at least a portion of a software image layout according to at least one example of the present disclosure.

FIG. 4 is a block diagram illustrating a hash table segment from the software image of FIG. 3 after signatures from both a vendor and an OEM are included.

FIG. 5 is a block diagram illustrating an example of a process for a second entity adding a second software image to operate in cooperation with the first software image.

FIG. 6 is a block diagram illustrating an example of a process for providing multiple signatures for software.

FIG. 7 is a flow diagram illustrating a method operational on an electronic device according to at least one example.

FIG. 8 is a flow diagram illustrating a method operational on an electronic device according to at least one other example.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

### Overview

Use of two or more signatures for software images, including bootloader and operating system software is presented for authenticating such images. In one or more embodiments, a first signature may come from a first entity, such as a software vendor, and a second signature may come from a second entity, such as an original equipment manufacturer (OEM). In some embodiments, the second entity may also include an additional software image configured to enable additional functionality on top of the functionality provided by the original software image from the first entity.

### Example Electronic Devices

Software is typically executed by an electronic device including processing capabilities. In some instances, it is desirable to include a signature with the software to verify that the software is approved for execution by the processing system. It is noted that although this description refers to “software” throughout, aspects of this disclosure are applicable to various kinds of programming, including without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

According to aspects of the present disclosure, electronic devices are adapted to enable software to be signed with more than one signature, and to employ software with more than one signature. For example, software may include a first signature, such as from a first entity, and a second signature, such as from a second entity. Additional signatures may also be included (e.g., third signature, fourth signature, etc.), but the present description will generally refer to just a first signature and a second signature for simplicity.

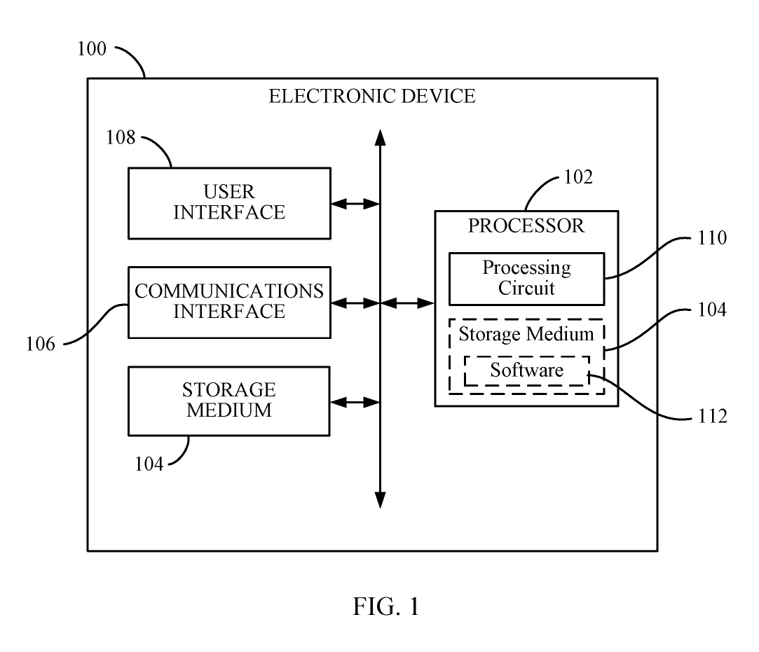

Referring now to FIG. 1, a block diagram is shown illustrating select components of an electronic device 100 according to at least one example of the present disclosure. Examples of a processing device 100 include a mobile phone, a pager, a wireless modem, a personal digital assistant, a personal information manager (PIM), a personal media player, a palmtop computer, a laptop computer, a tablet computer, a television, an appliance, an e-reader, a digital video recorder (DVR), a machine-to-machine (M2M) device, meter, entertainment device, sensor, sensing device, wearable device, router, and/or other computing device.

As shown in FIG. 1, the electronic device 100 may include a processor 102 coupled to or placed in electrical communication with a storage medium 104 and a communications interface 106. Additionally, in some examples, a user interface 108 may also be coupled to or placed in electrical communication with the processor 102.

The processor 102 is arranged to obtain, process and/or send data, control data access and storage, issue commands, and control other desired operations. The processor 102 may include circuitry, such as processing circuit 110, adapted to implement desired programming provided by appropriate media, and/or circuitry adapted to perform one or more functions described in this disclosure. For example, the processor 102 may be implemented as one or more processors, one or more controllers, and/or other structure configured to execute executable programming and/or execute specific functions. Examples of the processor 102 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processor 102 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processor 102 are for illustration and other suitable configurations within the scope of the present disclosure are also contemplated.

In some embodiments, the processor 102 may include circuitry adapted for processing, including the execution of software, which may be stored on the storage medium 104. The storage medium 104 may represent one or more processor-readable devices for storing software, electronic data, databases, or other digital information. The storage medium 104 may also be used for storing data that is manipulated by the processing circuit 102 when executing software. The storage medium 104 may be any available media that can be accessed by a general purpose or special purpose processor, including portable or fixed storage devices, optical storage devices, and various other mediums capable of storing, containing and/or carrying programming. By way of example and not limitation, the storage medium 104 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 104 may be coupled to the processor 102 such that the processor 102 can read information from, and write information to, the storage medium 104. That is, the storage medium 104 can be coupled to the processor 102 so that the storage medium 104 is at least accessible by the processor 102, including examples shown in FIG. 1 where the storage medium 104 is integral to the processor 102 and/or examples where the storage medium 104 is separate from the processing circuit 102 (e.g., resident in the electronic device 100, external to the electronic device 100, distributed across multiple entities).

The communications interface 106 is configured to facilitate wireless and/or wired communications of the electronic device 100. For example, the communications interface 106 may include circuitry and/or software adapted to facilitate the communication of information bi-directionally with respect to one or more wireless and/or wired network devices. Although FIG. 1 shows just one communications interface 106, the electronic device 100 may include two or more communication interfaces 106.

In some embodiments, an electronic device 100 can include a user interface 108. The user interface 108 may include circuitry and/or software for receiving input from a user of the electronic device 100, e.g., via a keyboard, a touchscreen, graphical user interface shown on a display of the electronic device 100, speech recognition circuitry, or an accessory device, such as a headset, and for providing output to the user, via, e.g. a graphical user interface or a speaker.

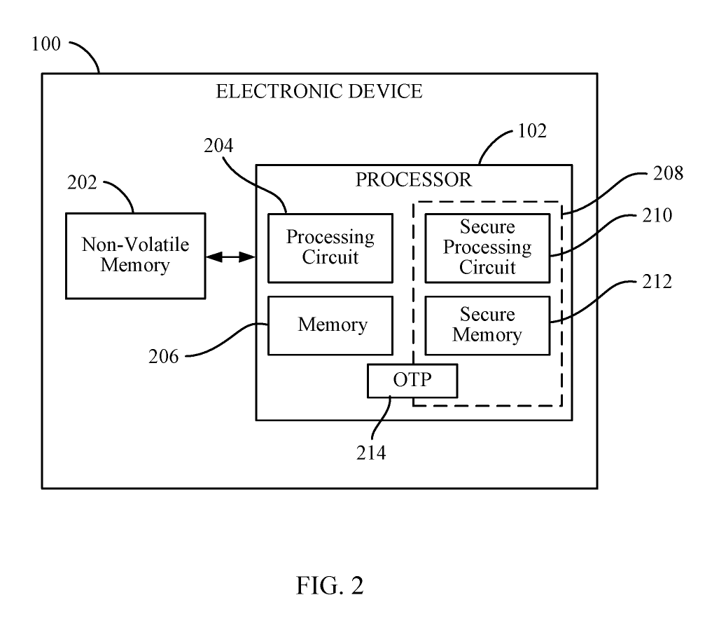

In some examples, the electronic device 100 may include a secure execution environment for executing security critical software and for manipulating sensitive content. Such a secure execution environment may also be referred to as a trust zone or TZ. FIG. 2 is a block diagram illustrating select components of the electronic device 100 including a secure execution environment. As shown, the electronic device 100 can include the processor 102 and a storage medium configured as a non-volatile memory 202 (e.g., flash memory). In the depicted example, the processor 102 includes a non-secured or normal processing circuit 204, a non-secured or normal storage medium identified as memory 206, and a secured execution environment 208. The secured execution environment 208 can include a secure processing circuit 210, a secure storage medium identified as memory 212, and access to a one-time programmable (OTP) memory 214. The secured execution environment 208 is logically and/or physically separated from the rest of the processing environment (normal processing circuit 204 and normal memory 206) where a majority of the software is typically executed. This makes the secured execution environment 208 a trusted and isolated environment from other software that may provide security services and functionality to the whole electronic device 100. One of the services that the secured execution environment 208 may provide is to authenticate that any new software is signed by at least one trusted source before allowing it to run on the electronic device 100.

In one or more examples, the secure memory 212 may include ROM from which the processor 102 is booted, including both application software and an operating system. A boot software may include the main functionality of the electronic device 100. The secure memory 212 may also include RAM for storage of protected data and applications, such as for performance of security critical operations inside the secured execution environment 208, as well as cryptographic keys, intermediate cryptographic calculation results and passwords. Protected applications may be employed by allowing normal applications to request services from a certain protected application.

### Example Software

Referring back to FIG. 1, the electronic device 100 further includes software 112 stored in one or more portions of the storage medium 104. The software 112 may be stored in any portion of the storage medium 104, including the non-volatile memory 202, the normal memory 206, and/or the secure memory 212 described above with reference to FIG. 2. In at least one example, the software 112 is stored in the secure memory 212, and may include bootloader software.

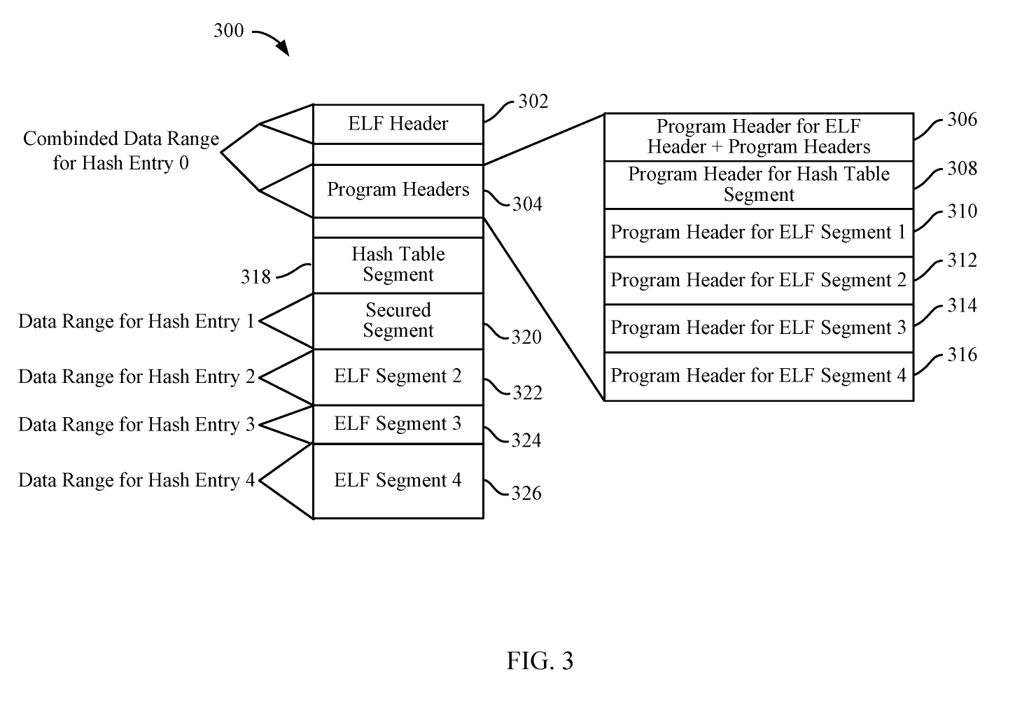

Turning to FIG. 3, a block diagram is shown illustrating at least a portion of a software image layout 300 for the software 112 according to at least one example. The software image layout 300 shows the packaging of software signed by a first entity (e.g., a vendor) within an image from a second entity (e.g., original equipment manufacturer (OEM)). For example, the software image layout 300 can represent a secured portion of a bootloader software provided by a first entity that can be packaged within bootloader software provided by a second entity. As shown, the software image layout 300 is an executable and linkable format (ELF), which may also be referred to as an extensible linking format. The ELF includes an ELF header 302 and program headers 304. In this example, the program headers 304 include a program header 306 for the ELF header 302 and program headers, a program header 308 for a hash table segment, a program header 310 for ELF segment 1, a program header 312 for ELF segment 2, a program header 314 for ELF segment 3, and a program header 316 for ELF segment 4. These items combined are employed for a first hash entry, Hash Entry 0.

The ELF further includes a hash table segment 318. A secured segment 320 is included and is used as the data range for a second hash entry (Hash Entry 1). The secured segment 320 may, for example, include the secured portion of the bootloader software provided by the first entity. Additional ELF segments may also be included. For instance, ELF segment 2 identified by element number 322 is included and is used as the data range for a third hash entry (Hash Entry 2), ELF segment 3 identified by element number 324 is used for a fourth hash entry (Hash Entry 3), and ELF segment 4 identified by element number 326 is used for a fifth hash entry (Hash Entry 4). These additional ELF segments 322, 324, and 326 may represent non-secured software segments.

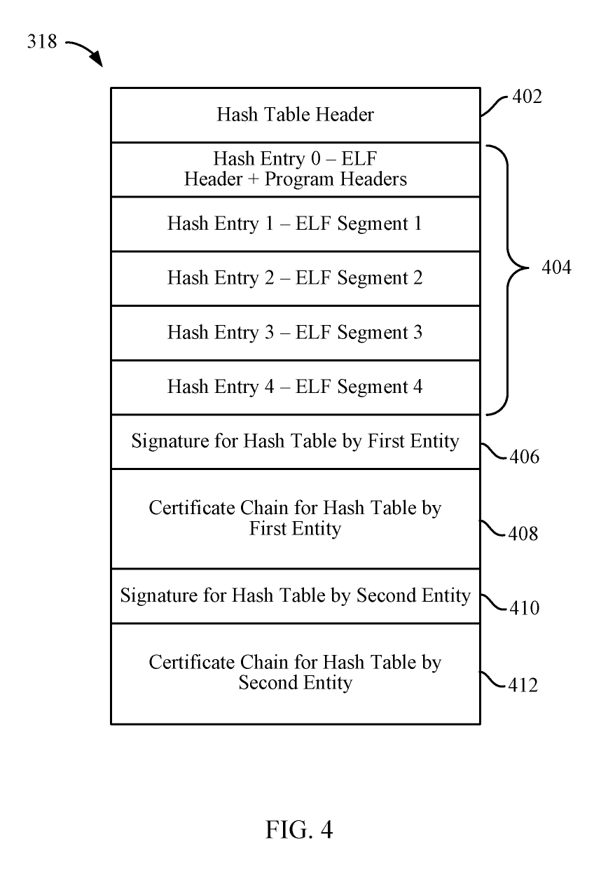

In at least one example, the signatures by multiple entities are included as part of the hash table segment 318 of the software image 300. These signatures are associated with the hash table instead of the whole portion of the software. FIG. 4 illustrates a block diagram of the hash table segment 318 from FIG. 3 with signatures from two entities according to at least one such example. As shown in FIG. 4, the hash table segment 318 can include a hash table header 402 together with a plurality of hash entries 404, such as the five hash entries referred to above with reference to FIG. 3. The hash table header 402 can indicate information about the signatures and the certificate chains. Each of the hash entries 404 are for a respective ELF segment in the present example. Following the last hash entry, e.g., Hash Entry 4 in the illustrated example, the hash table segment 318 includes a signature 406 for the hash table by the first entity, followed by a certificate chain 408 for the hash table by the first entity. The hash table segment 318 then includes a signature 410 for the hash table by the second entity, followed by a certificate chain 412 for the hash table by the second entity. As noted previously, signatures and certificate chains from additional entities may also be included.

Employing multiple signatures in a hash table as described can enable a first entity, such as a software vendor, to sign and authenticate software developed by the vendor and send that signed software to a second entity, such as an original equipment manufacturer (OEM). As used herein, a vendor may represent an entity or company that originally prepared the software. A vendor may sell or otherwise provide the software to a second entity, such as an OEM, for use in a product manufactured or sold by the OEM.

Typically, the vendor sells or otherwise provides the software (e.g., firmware) for different types of devices that, when executed by the devices, creates an integral platform. This software historically could be modified by the OEM or third parties. To protect the integrity of the platform, the vendor in the present disclosure can verify its software by signing the software provided to the OEM using the vendor's own key. This generates trust of the software provided by the vendor.

According to at least one aspect of the disclosure, the OEM may have the ability to also sign the software to authorize which software or part of the software provided from the vendor can be run on their platform, since the software will not be executed without a signature from both the vendor and the OEM. Additionally, the vendor maintains control over the integrity of the original software without impacting the OEM's end-to-end flow of testing and signing off on the software. Accordingly, the OEM has the ability to sign one software image while not signing another, so the signed software image will be executable by the device while the unsigned software image is not executable by the device. Enabling the OEM to also sign the vendor's software also provides control to the OEM over the vendor's software, since the vendor will not be able to update the vendor's software without the permission of the OEM.

In some implementations, the second entity may further include additional portions of software configured to operate in coordination with the original software provided by the first entity. For example, the second entity may be an OEM and may wish to provide additional functionality to the device in which the original software provided from the first entity is implemented. The second entity may accordingly provide a second software image to operate over the first software image. In such examples, the second software is signed by the second entity using the second entity's key.

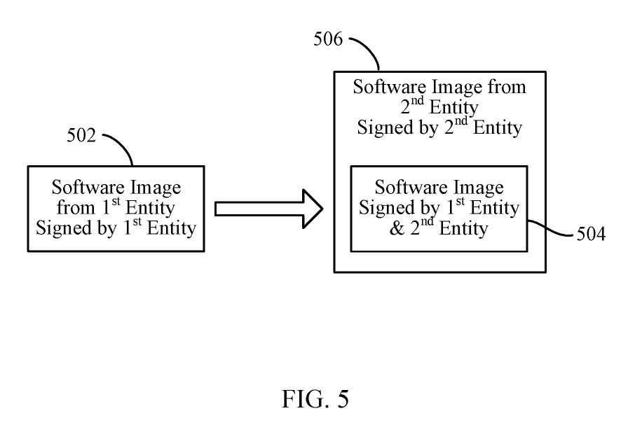

An example of such an implementation is depicted in the block diagram of FIG. 5. As shown, a first software image 502 is provided from the first entity. The first software image is signed by the first entity and delivered to the second entity. For example, the first entity may provide a software image 300 with the first entity's signature 406 and certificate chain 408, as described above with reference to FIGS. 3 and 4. The second entity receives the first software image and can sign the first software image 504 as described above. For example, the second entity may add its signature 410 and certificate chain 412 to the software image 300, as described above with reference to FIG. 4. Additionally, the second entity can provide a second software image 506 to operate with the first software image. For example, the second entity may package the first software image 504 within the second software image 506. The second entity also signs the second software image 506, and the first and second software images 504, 506 are stored on a storage medium of an electronic device, such as the storage medium 104 of the electronic device 100 in FIG. 1.

In this example, the first software image is always protected against any modifications by the first entity (e.g., the vendor), the second entity (e.g., the OEM), or a third party without the consent of both the first entity and the second entity, since the first and second entities both sign the first software image. Additionally, the second software image is always protected against modifications by the first entity or a third party without the consent of the second entity, since the second software image is signed by the second entity.

Example of Providing Software with Signatures from Two Entities

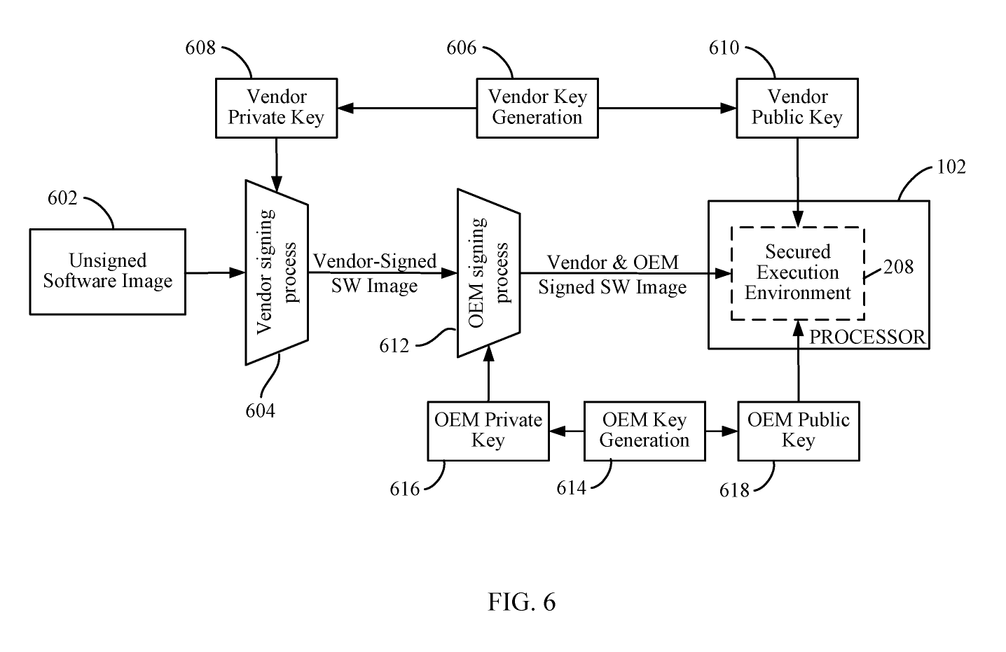

Referring to FIG. 6, an example process is depicted for providing signatures from multiple entities for software. In at least one example, the first signing entity may be a vendor of the software, while a second signing entity may be an OEM.

As shown, an unsigned software image 602 can initially be provided. The unsigned software image 602 can be signed by a vendor using a vendor private key from a conventional private and public key pair. For example, an unsigned software image 602 is initially signed by the vendor using a conventional signing process 604. For example, the vendor may perform a conventional key generation process 606 resulting in a first private-public key pair including the vendor private key 608 and vendor public key 610. The vendor private key 608 may then be used to sign the unsigned software image 602. The vendor signature and certificate chain is included in the hash table segment, as described with reference to FIG. 4 above.

The vendor-signed software image is subsequently signed by the OEM using a conventional signing process 612. For example, the OEM may perform a conventional key generation process 614 resulting in a second private-public key pair including the OEM private key 616 and the OEM public key 618. The OEM private key 616 can then be used to add the OEM signature to the vendor-signed software image. The OEM signature and certificate chain is added to the hash table segment, as described with reference to FIG. 4 above.

After the software image is signed by both the vendor and the OEM, the dual-signed software image can be provided to the secured execution environment 208 of the processor 102 of an electronic device 100. Additionally, the public keys that can be employed by the secured execution environment 208 to validate the signatures can also be provided to the secured execution environment 208 of the processor 102.

As noted above, the vendor may, in some implementations, further provide a second software image to operate in addition to the vendor-provided software image, and may also sign the second software image with the OEM private key 616 or a second OEM private key. The OEM signature and a certificate chain can be added to a hash table segment for the second software image as described above. In such implementations, the second software image can be provided to the secured execution environment 208 together with the first software image.

Examples of Executing Software Signed with Two Signatures

According to one or more aspects of the present disclosure, the electronic device 100 may be configured execute the stored software 112 only after authenticating the respective signature from each of the first entity and the second entity. For instance, a software image that is signed by the first entity but lacks a signature from the second entity may not be executable by the electronic device 100.

On the other hand, when the software is signed by both of the first and second entities, the electronic device 100 can execute that software after authenticating each of the two signatures. For example, a software image, such as the ELF 300 in FIG. 3, can be loaded from the secure memory 212. The secure processing circuit 208 can authenticate the software image against the signature from the first entity (e.g., vendor signature) and the signature from the second entity (e.g., OEM signature). According to the example described above with reference to FIG. 6, a signed software image can be loaded and the secure processing circuit 208 can first authenticate the vendor signature, such as by using the vendor public key 610 to authenticate the vendor signature. If the vendor signature is authenticated, the secure processing circuit 208 can then authenticate the OEM signature associated with the software image, such as by using the OEM public key 618 to authenticate the OEM signature. It is noted that the order of authentication can also be reversed. That is, the OEM signature can be authenticated first and the vendor signature can be authenticated second, after the OEM signature is successfully authenticated. In at least one example of the present disclosure, the authentication of the first and second signatures may be performed in an exception level of the processor commonly referred to as EL3.

After the vendor signature and the OEM signature are authenticated, the secure processing circuit 208 may execute the associated software or a portion thereof in the secured execution environment 208 and/or may pass the software or a portion thereof to the non-secure processing circuit 204 for further execution of the software by the processor 102.

In implementations where a first software image is packaged within a second software image, as described above with reference to FIG. 5, the second software image may initially be authenticated. For example, a software image including a first software image and a second software image, such as the first software image 504 and second software image 506 in FIG. 5, can be loaded from the secure memory 212. The secure processing circuit 208 can initially authenticate the second software image against the signature from the second entity (e.g., OEM signature). If the second software image is authenticated, then the secure processing circuit 208 can authenticate the first software image against the signature from the first entity (e.g., vendor signature) and the signature from the second entity (e.g., OEM signature).

According to the example described above with reference to FIG. 6, a signed software image including a first software image packaged within a second software image can be loaded, and the secure processing circuit 208 can first authenticate the OEM signature of the second software image, such as by using the OEM public key 618 to authenticate the OEM signature. If the OEM signature of the second software image is authenticated, the secure processing circuit 208 can then authenticate the vendor signature for the first software image, such as by using the vendor public key 610 to authenticate the vendor signature. If the vendor signature is authenticated for the first software image, the secure processing circuit 208 can then authenticate the OEM signature associated with the first software image, such as by using the OEM public key 618 to authenticate the OEM signature. As noted above, the order of authentication for the first software image can be reversed. In at least one example of the present disclosure, the authentication of the first and second software images may be performed in an exception level of the processor commonly referred to as EL3.

After the first and second software images are authenticated, the secure processing circuit 208 may execute the associated software or a portion thereof in the secured execution environment 208 and/or may pass the software or a portion thereof to the non-secure processing circuit 204 for further execution of the software by the processor 102.

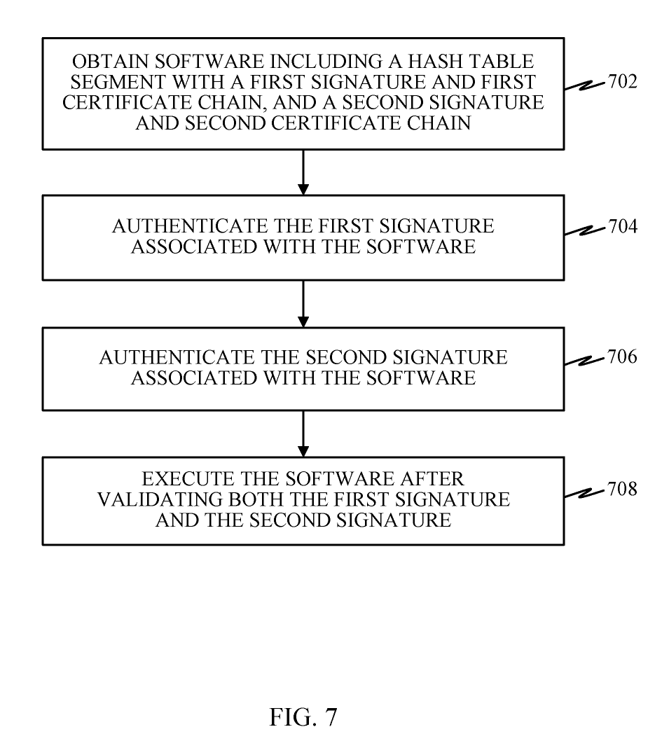

Turning to FIG. 7, a flow diagram is shown illustrating a method operational on an electronic device, such as electronic device 100, according to at least one example. Referring to FIGS. 1-4, 6, and 7, the electronic device 100 may obtain a first software including a hash table segment with a first signature and first certificate chain, and a second signature and second certificate chain at 702. For example, the electronic device 100 may obtain software 112 to store in the storage medium 104. The software 112 may include a hash table segment 318 with at least one hash entry, where each hash entry is associated with a respective data range from the software image. In addition, the software 112 includes a first signature 406 and first certificate chain 408 from a first entity for the at least one hash entry, and a second signature 410 and second certification chain 412 from a second entity for the at least one hash entry. According to various implementations, the software with the hash table segment may be provisioned or otherwise stored in the secure memory 212 of the secured execution environment 208 of the processor 102. According to some implementations, the software with the hash table segment may include a bootloader software image.

In implementations where the software 112 includes the first software portion and the second software portion, the signature associated with the second software portion can be authenticated at operation block 703. For instance, the signature associated with the second software portion may be authenticated by utilizing a public key associated with the second entity (e.g. OEM public key 318) to authenticate the signature generated using a private key associated with the second entity's public key (e.g., OEM private key 316). Operation block 703 is depicted in broken lines to illustrate that this step is skipped in implementations where there is not a signed second software portion.

At 704, the first signature may be authenticated. For example, the secure processing circuit 210 may authenticate the first signature. In at least one implementation, the authentication of the first signature may be accomplished by utilizing a first public key (e.g. vendor public key 310) to authenticate the first signature generated using a first private key (e.g., vendor private key 308) associated with the first public key.

At 706, the second signature may be authenticated. For example, the secure processing circuit 210 may authenticate the second signature. In at least one implementation, the authentication of the second signature may be accomplished by utilizing a second public key (e.g. OEM public key 318) to authenticate the second signature generated using a second private key (e.g., OEM private key 316) associated with the second public key.

At 708, if both the first signature and the second signature are authenticated, the electronic device 100 can execute the software. For example, the secure processing circuit 210 and/or the non-secured or normal processing circuit 204 may execute the software after it is authenticated.

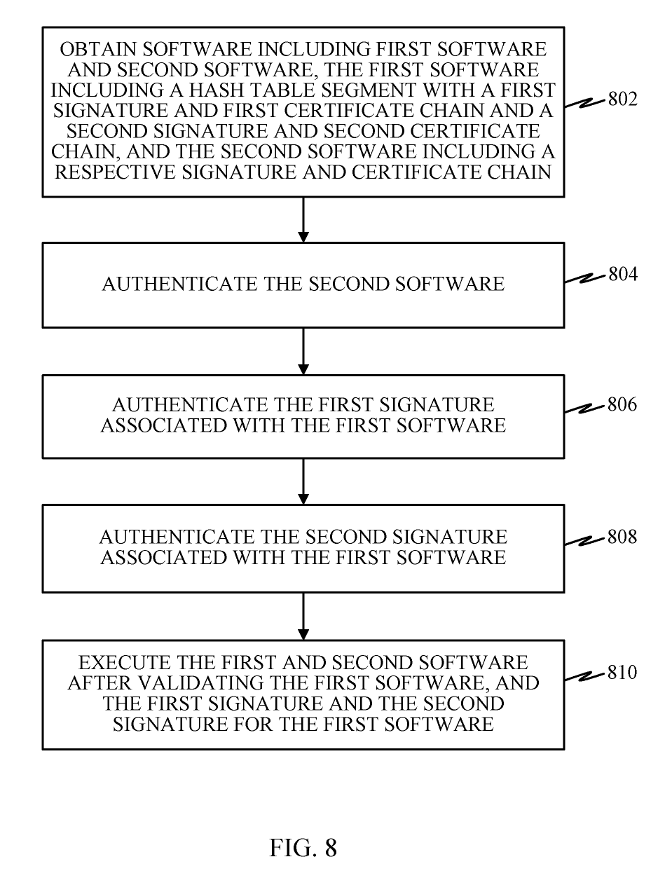

As described above, the software 112 may, in some implementations, include a first signed software portion and a second signed software portion, where the first signed software portion is packaged within the second signed software portion. FIG. 8 is a flow diagram illustrating a method operational on an electronic device, such as electronic device 100, according to at least one other example. Referring to FIGS. 1-7, the electronic device 100 may obtain software including first software and second software at 802. The first software may include a hash table segment with a first signature and first certificate chain associated with a first entity, and a second signature and second certificate chain associated with a second entity.

For example, the electronic device 100 may obtain software 112 to store in the storage medium 104. The software 112 may include first software 504 including a hash table segment 318 with at least one hash entry, where each hash entry is associated with a respective data range from the software image. In addition, the first software 504 includes a first signature 406 and first certificate chain 408 from a first entity for the at least one hash entry, and a second signature 410 and second certification chain 412 from a second entity for the at least one hash entry. The software 112 may further include second software 506 including a signature and certification chain from the second entity.

According to various implementations, the first software 504 may be included within the second software 506, and/or may operate in coordination with the first software. The software 112 may be provisioned or otherwise stored in the secure memory 212 of the secured execution environment 208 of the processor 102. According to some implementations, the software 112 may include a bootloader software image.

At 804, the second software may be authenticated. For example, the secure processing circuit 210 may authenticate the signature for the second software. In at least one implementation, the authentication of the second software may be accomplished by utilizing a public key associated with the second entity (e.g. OEM public key 318) to authenticate the signature generated using a private key associated with the second entity's public key (e.g., OEM private key 316).

At 806, the first signature for the first software may be authenticated. For example, the secure processing circuit 210 may authenticate the first signature for the first software. In at least one implementation, the authentication of the first signature for the first software may be accomplished by utilizing a first public key (e.g. vendor public key 310) to authenticate the first signature generated using a first private key (e.g., vendor private key 308) associated with the first public key.

At 808, the second signature for the first software may be authenticated. For example, the secure processing circuit 210 may authenticate the second signature for the first software. In at least one implementation, the authentication of the second signature for the first software may be accomplished by utilizing a second public key (e.g. OEM public key 318) to authenticate the second signature generated using a second private key (e.g., OEM private key 316) associated with the second public key.

At 810, if each of the second software, the first signature for the first software, and the second signature for the first software are authenticated, the electronic device 100 can execute the software. For example, the secure processing circuit 210 and/or the non-secured or normal processing circuit 204 may execute the software 112 after all portions have been authenticated.

While the above discussed aspects, arrangements, and embodiments are discussed with specific details and particularity, one or more of the components, steps, features and/or functions illustrated in FIGS. 1, 2, 3, 4, 5, 6, 7, and/or 8 may be rearranged and/or combined into a single component, step, feature or function or embodied in several components, steps, or functions. Additional elements, components, steps, and/or functions may also be added or not utilized without departing from the present disclosure. The apparatus, devices and/or components illustrated in FIGS. 1, 2, and/or 6 may be configured to perform or employ one or more of the methods, features, parameters, and/or steps described in FIGS. 3, 4, 5, 7, and/or 8. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. An electronic device, comprising:
a storage medium storing a first software comprising a hash table segment, the hash table segment comprising at least one hash entry, a first signature and first certificate chain from a first entity for the at least one hash entry, and a second signature and second certificate chain from a second entity for the at least one hash entry; and
a processing circuit coupled to the storage medium, the processing circuit adapted to:
validate the first signature and the second signature; and
execute the software after validating both the first signature and the second signature.

2. The electronic device of claim 1, wherein the first entity is a vendor of the first software, and the second entity is an original equipment manufacturer for the electronic device.

3. The electronic device of claim 1, wherein the first software comprising the hash table segment is stored in a secured portion of the storage medium located within a secured execution environment.

4. The electronic device of claim 1, wherein the processing circuit comprises a secured processing circuit located within a secured execution environment.

5. The electronic device of claim 1, wherein the first software comprises a bootloader software.

6. The electronic device of claim 1, wherein the storage medium further comprises a second software stored therein, the second software configured to operate in coordination with the first software and comprising a second hash table segment, the second hash table segment including at least one hash entry, and a signature and certificate chain from the second entity.

7. The electronic device of claim 6, wherein the first software is included within the second software.

8. A method operational on an electronic device, comprising:
obtaining a first software comprising a hash table segment, the hash table segment comprising at least one hash entry, a first signature and first certificate chain from a first entity for the at least one hash entry, and a second signature and second certificate chain from a second entity for the at least one hash entry;
validating the first signature;
validating the second signature; and
executing the first software after validating both the first signature and the second signature.

9. The method of claim 8, wherein the first entity is a vendor of the software, and the second entity is an original equipment manufacturer for the electronic device.

10. The method of claim 8, wherein obtaining the first software comprising the hash table segment comprises:
storing the first software in a secured portion of a storage medium located within a secured execution environment of the electronic device.

11. The method of claim 8, wherein:
validating the first signature comprises validating the first signature in a secured processing circuit located within a secured execution environment of the electronic device; and
validating the second signature comprises validating the second signature in the secured processing circuit.

12. The method of claim 8, wherein obtaining the first software comprising the hash table segment comprises:
obtaining a bootloader software image comprising the hash table segment.

13. The method of claim 8, further comprising:
obtaining a second software configured to operate in coordination with the first software, the second software comprising a second hash table segment including at least one hash entry, and a signature and certificate chain from the second entity.

14. The method of claim 13, wherein the first software is packaged within the second software.

15. An electronic device, comprising:
means for storing a first software comprising a hash table segment, the hash table segment comprising at least one hash entry, a first signature and first certificate chain from a first entity for the at least one hash entry, and a second signature and second certificate chain from a second entity for the at least one hash entry;
means for validating the first signature;
means for validating the second signature; and
means for executing the first software after both the first signature and the second signature have been validated.

16. The electronic device of claim 15, wherein the means for storing the first software comprises:
means for storing the first software in a secured execution environment.

17. The electronic device of claim 15, wherein:
the means for validating the first signature comprises means for validating the first signature in a secured execution environment; and
the means for validating the second signature comprises means for validating the second signature in the secured execution environment.

18. The electronic device of claim 15, wherein the first entity is a vendor of the first software, and the second entity is an original equipment manufacturer for the electronic device.

19. The electronic device of claim 15, wherein the first software comprises a bootloader software.

20. The electronic device of claim 15, further comprising:
means for storing a second software configured to operate in coordination with the first software, the second software comprising a second hash table segment including at least one hash entry, and a signature and certificate chain from the second entity.

21. The electronic device of claim 20, wherein the first software is packaged within the second software.

22. A non-transitory processor-readable storage medium storing processor-executable programming for causing a processing circuit to:
store a first software comprising a hash table segment, the hash table segment comprising at least one hash entry, a first signature and first certificate chain from a first entity for the at least one hash entry, and a second signature and second certificate chain from a second entity for the at least one hash entry;
authenticate the first signature;
authenticate the second signature; and
execute the first software after both the first signature and the second signature have been authenticated.

23. The processor-readable storage medium of claim 22, wherein the first entity is a vendor of the first software, and the second entity is an original equipment manufacturer for the electronic device.

24. The processor-readable storage medium of claim 22, wherein the processor-executable programming for causing a processing circuit to store the first software comprises:
processor-executable programming for causing a processing circuit to store the first software in a secured portion of a storage medium located within a secured execution environment.

25. The processor-readable storage medium of claim 22, wherein:
the processor-executable programming for causing a processing circuit to validate the first signature comprises processor-executable programming for causing a processing circuit to validate the first signature in a secured execution environment; and
the processor-executable programming for causing a processing circuit to validate the second signature comprises processor-executable programming for causing a processing circuit to validate the second signature in the secured execution environment.

26. The processor-readable storage medium of claim 22, wherein the first software comprises a bootloader software.

27. The processor-readable storage medium of claim 22, further comprising:
processor-executable programming for causing a processing circuit to store a second software configured to operate in coordination with the first software, the second software comprising a second hash table segment including at least one hash entry, and a signature and certificate chain from the second entity.

28. The processor-readable storage medium of claim 27, wherein the first software is included within the second software.
